(19) United States
(12) Patent Application Publication
(10) Pub. No.: US 2014/0369825 A1
(43) Pub. Date: Dec. 18, 2014

(54) WATER POWER PLANT COMPRISING A BRANCH PART

(71) Applicant: Voith Patent GmbH, Heidenheim (DE)

(72) Inventor: Manfred Stummer, Heidenheim (DE)

(73) Assignee: Voith Patent GmbH, Heidenheim (DE)

(21) Appl. No.: 14/378,910

(22) PCT Filed: Dec. 27, 2012
(86) PCT No.: PCT/EP2012/076923

§ 371 Date: Aug. 14, 2014

(30) Foreign Application Priority Data
Feb. 15, 2012 (DE) 10 2012 002 809.1

(51) Int. Cl. F03B 3/10

(52) U.S. Cl. CPC F03B 3/106
USPC 415/204

(57) ABSTRACT

The invention relates to a line system for a water power plant, comprising the following features and components: a turbine having a turbine impeller and a turbine spiral housing, a pump having a pump impeller and a pump spiral housing, the two spiral housings being arranged to run in opposite directions to one another, a shaft on which the turbine impeller and the pumpkin impeller are arranged in a rotationally fixed manner, an electric machine that has a drive connection to the shaft or can connected thereto, the pressure lines of the two spiral housings opening in a common line pressure line, a turbine pressure line for introducing water out of the main pressure line into a pump turbine in turbine operation, a pump pressure line configured as a bend for introducing water out of the pump turbine into the main pressure line in pump operation or back through the turbine pressure line to the pump turbine in a hydraulic short circuit, and a branch part to which the main pressure line, the turbine pressure line and the pump pressure line are connected. The invention is characterized by the following features: the flow cross section of the bend is larger at the outlet therefrom than at the inlet thereto.

The invention concerns the field of the water power plants. Such a water power plant includes at least two hydraulic machines. One of these machines at least is a pump.

A pump turbine unit is fitted with a pump and a turbine as well as a generator between an upper water pool and a lower water pool. At times of high requirement of electric energy, water flows through a main pressure line from the upper water pool through the turbine to the lower water pool.

At times of minimal requirement of electric energy, the pump turbine functions as a pump. It is driven by an electrical machine which then functions as an electric motor. The pump then conveys water from the lower water pool through a pump pressure line as well as through the main pressure line to the upper water pool. It is also possible to work for regulating the power in the hydraulic short-circuit. To do so, a portion or the whole pump flow rate is guided to the turbine.

The plant includes a branch part. The main pressure line, the turbine pressure line as well as the pump pressure line are connected to said plant. The pump pressure line contains a bend.

Every flow of a liquid in a pipework is knowingly lossy. The flow losses are particularly high with a flow redirection. This is also valid for a pipe bend or for a branch part.

The object of the invention is then to design a pump turbine plant according to the preamble of claim 1 in such a way that the flow losses are reduced in the bend of the pump pressure line as well as in the branch part.

Said object is met by means of a pump turbine plant which presents the features of the characterising part of claim 1.

Consequently, the bend of the pump pressure line is designed as a so-called delay bend, i.e. the cross-sectional surface of the pump pressure line increases before the inlet into the branch part. The result is a certain delay of the flow. The flow loss is therefore reduced in the bend properly speaking as well as in the branch part connected downstream.

The delay bend can be extended continuously. Said bend can consist of a plurality of segments whose cross-sectional surface increases from segment to segment, as seen in the flow direction.

The invention is described below with reference to the drawing. The following details are shown:

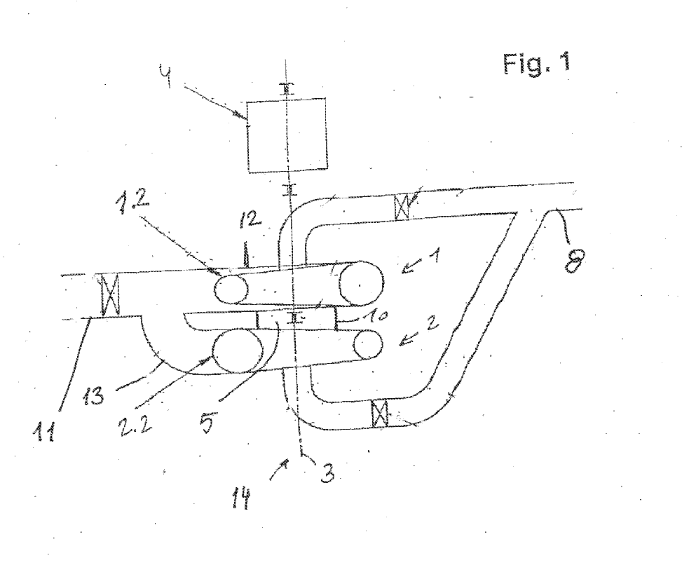

FIG. 1 shows a diagrammatic illustration of a pump turbine plant with a vertical shaft in a side view.

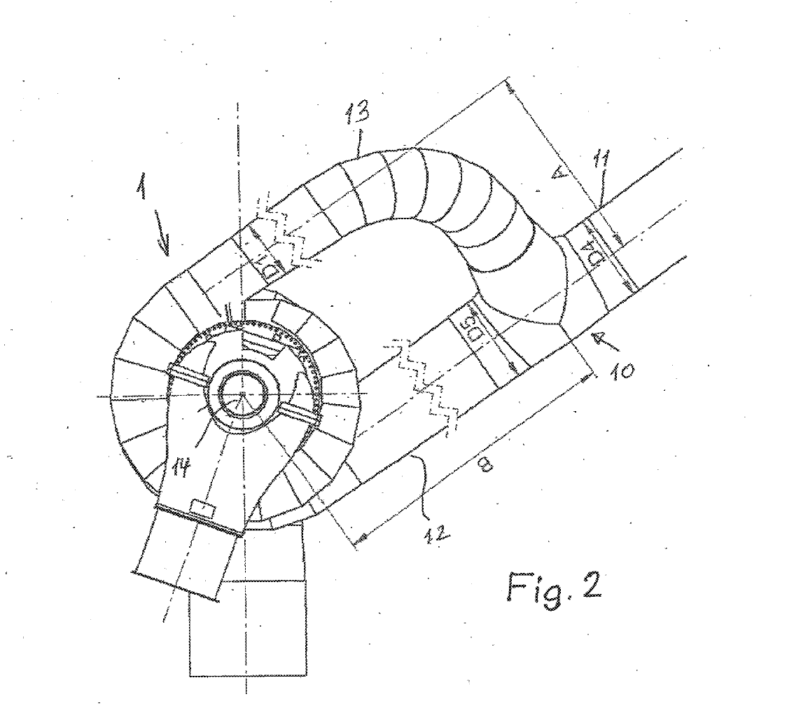

FIG. 2 shows in a schematical view a pump turbine plant, seen in the direction of the rotational axis.

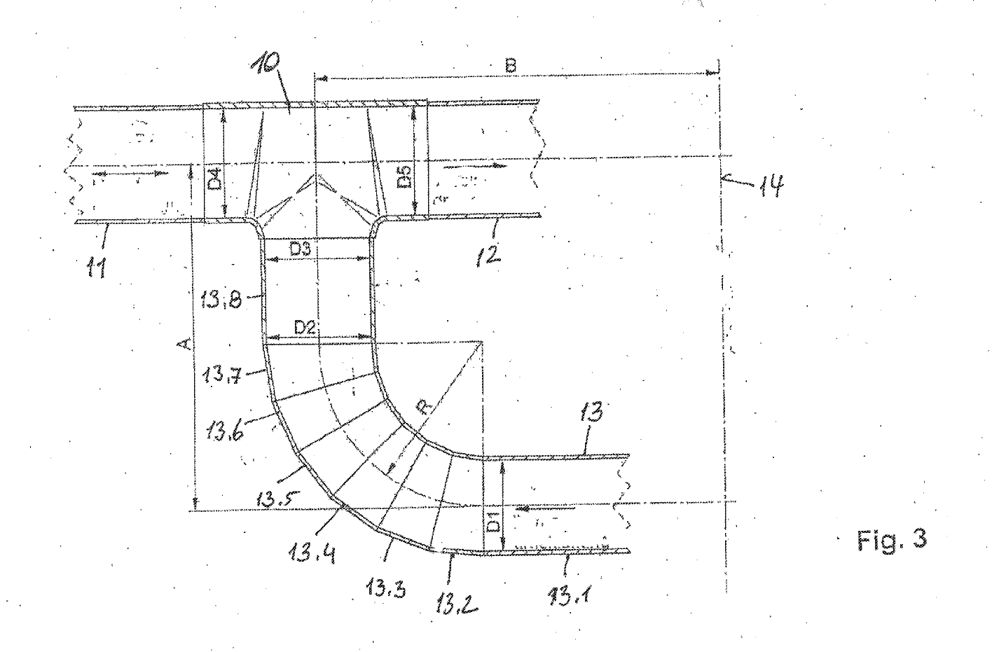

FIG. 3 shows the relevant parts of FIG. 2, i.e. a branch part, a main pressure line, a turbine pressure line as well as a pump pressure line in the form of a bend.

As can be seen in FIG. 1, a pressure line 13 is connected to the turbine spiral housing 1.2 as well as a pressure line 13 is connected to the pump spiral housing 2.2. Both pressure lines 12, 13 are connected to the pressure line 11 via a branch part 10 in which a common shut-off device 6.1 is situated.

The plant shown in FIG. 2 comprises a pump and a turbine 1. It is represented in elevation view on the rotational axis 14.

A branch part 10 can be seen. A main pressure line 11, a turbine pressure line 12 as well as a pump pressure line 13 in the form of a bend are connected to said branch part. The pump pressure line 13 consists of individual segments, to which we shall come back, the same goes for the measurements A and B.

The pipe system shown in FIG. 3 includes a branch part 10 as a central element. The main pressure line 11, the turbine pressure line 12 as well as the pump pressure line 13 designed as a bend are connected to the branch part 10.

The rotational axis 14 of the hydraulic machine can be seen.

The design of the pump pressure line 13 is of vital importance. A cylindrical segment 13.1 of the pump pressure line is connected to the pump turbine non-illustrated here. Conical segments 13.2 to 13.7 follow. The cross-sections of the conical segments widen from segment to segment. A cylindrical segment 13.8, emerging in the branch part 10, follows.

The main pressure line 11, the branch part 10 as well as the turbine pressure line 12 conversely exhibit the same constant flow cross-section.

The flow directions are indicated by arrows. The main pressure line 11 is shown by a double arrow to indicate both possible flow directions. The flow runs (coming from the upper water pool) through the branch part 10 and the turbine pressure line 12 while the turbine is in operation. While the pump is in operation, the flow runs, coming from the lower water pool, through the pump pressure line 13, through the branch part 10, through the main pressure line 11 to the upper water pool.

The inlet diameter of the delay bend, i.e. the inlet diameter of segment 13.2, is identical to the diameter DI of the cylindrical segment 13.1. It could also be larger.

The segment 13.8 can also be designed conically, so that it widens in the flow direction of the pump.

The segment 13.8 has a slightly larger outlet diameter D3 than its inlet diameter D2. Here, the inside of the segment 13.8 increases. The segment 13.8 can also be cylindrical. Accordingly, the inlet diameter D2 and the outlet diameter D3 are identical.

The segments 13.3 to 13.7 can also widen continuously.

The radius R of the delay bend is identical to 1.1 to 10 times of the inlet diameter DI.

The distance A between the central axis (central current path) of the main pressure line 11 and of the central axis of the pump pressure line 13 ranges between 2 and 200 times the inlet diameter DI.

The distance B between the central axis of the segment 13.8 and of the rotational axis 14 of the hydrodynamic machine ranges between 2 and 200 times the diameter D5 of the turbine pressure line 12.

The diameter D5 of the turbine pressure line 12 is identical to the outlet diameter D3 of the delay bend or larger than said diameter.

The diameter D5 of the turbine pressure line 12 is identical with the inlet diameter D2 of the segment 13.8 or in other words, the outlet diameter of the delay bend.

The diameter D5 of the turbine pressure line 12 can be up to five times greater than the outlet diameter D2 of the delay bend.

Both diameters D4 and D5 can be identical.

The inlet diameter D2 and the outlet diameter D3 of the segment 13.8 can be identical. However, D3 can be greater than D2. The diameter D3 can then be up to five times greater than the diameter D2.

### LIST OF REFERENCE SIGNS

1 Turbine
1.1 Turbine impeller
1.2 Turbine spiral housing
1.2.1 Guide vane
1.6 Shut-off device
2 Pump
2.1 Pump impeller
2.2 Pump spiral housing
3 Shaft
4 Electric machine
6.1 Shut-off device
7 Rotational axis
8 Suction line
9 Bearing
10 Branch part
11 Main pressure line
12 Turbine pressure line
13 Pump pressure line
13.1 Cylindrical segment
13.2-13.7 Conical segments
13.8 Cylindrical segment
14 Rotational axis

1: A pump turbine plant, comprising
a turbine with a turbine impeller as well as a turbine spiral casing;
a pump with a pump impeller as well as a pump spiral casing;
both spiral casings are arranged in opposite directions to each other;
a shaft, on which the turbine impeller and the pump impeller are arranged in a rotationally fixed manner;
an electric machine, which is in a drive connection with the shaft or can be brought into said connection;
the pressure lines of both spiral casings emerge in a common main pressure line;
a turbine pressure line for introducing water out of the main pressure line into a pump turbine while the turbine is in operation;
a pump pressure line configured as a bend for introducing water out of the pump turbine into the main pressure line while the pump is in operation, or back through the turbine pressure line to the pump turbine in case of hydraulic short-circuit;
a branch part, to which the main pressure line, the turbine pressure line as well as the pump pressure line are connected, characterised by the following features:
the flow cross-section of the bend is larger at the outlet therefrom than at the inlet therefrom.

2. A pump turbine plant according to claim 1, characterised by the following features:
the pump pressure line includes at least on one section of its course in flow direction a segment, on which the flow cross-section widens.

3. A pump turbine plant according to claim 1, characterised in that the inlet diameter (DI) of the bend is identical to or greater than the diameter of the pump pressure line.

4. A pump turbine plant according to claim 1, characterised in that a conical or cylindrical tube section is provided between the bend and the branch part.

5. A pump turbine plant according to claim 1, characterised in that the bend is cast or welded together out of pipe segments.

6. A pump turbine plant according to claim 1, characterised in that the branch part is connected directly to the bend.

7. A pump turbine plant according to claim 1, characterised in that a pipe segment is interposed between the bend and the branch part.

8. A pump turbine plant according to claim 1, characterised in that the cross-section of the bend widens continuously in flow direction.

9. A pump turbine plant according to claim 1, characterised in that the radius (R) of the bend ranges between 1.1 and 10 times the inlet diameter (DI).

10. A pump turbine plant according to claim 1, characterised in that the distance (A) between the main pressure line and the pump pressure line ranges between 2 and 200 times the inlet diameter (DI) of the bend.

11. A pump turbine plant according to claim 1, characterised in that the distance (B) between the rotational axis of the hydraulic machine and the centre of the branch part ranges between 2 and 200 times of the diameter (D5) of the turbine pressure line.

12. A pump turbine plant according to claim 1, characterised in that the outlet diameter (D2) of the bend ranges between 1.1 and 5 times the inlet diameter (DI) of the bend.

13. A pump turbine plant according to claim 1, characterised in that the diameter (D5) of the turbine pressure line ranges between 1.1 and 5 times of the diameter (D1) of the pump pressure line.

14. A pump turbine plant according to claim 1, characterised in that the diameter (D5) of the turbine pressure line is identical to the outlet diameter (D2) of the bend.

15. A pump turbine plant according to claim 1, characterised in that the diameter (D5) of the turbine pressure line is up to five times greater than the outlet diameter (D2) of the bend.

16. A pump turbine plant according to claim 1, characterised in that the diameter (D4) of the main pressure line is identical to the diameter (D5) of the turbine pressure line.

17. A pump turbine plant according to claim 1, characterised in that the diameter (D4) of the main pressure line amounts up to five times of the diameter (D5) of the turbine pressure line.

18. A pump turbine plant according to claim 1, characterised in that the diameters (D3 and D2) of the segment connected between the bend and the branch part are identical.

19. A pump turbine plant according to claim 1, characterised in that the diameter (D3) of the segment is up to five times greater than the diameter (D2).
